(19) United States
(12) Patent Application Publication
(10) Pub. No.: US 2006/0020842 A1
(43) Pub. Date: Jan. 26, 2006

(54) Timer management for reducing power consumption and workload in computers

(75) Inventors: Claus Michael Olsen, Cortlandt Manor, NY (US); Chandrasekhar Narayanaswami, Wilton, CT (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 10/899,349

(22) Filed: Jul. 26, 2004

(51) Int. Cl. G06F 1/04

(52) U.S. Cl. 713/502

(57) ABSTRACT

A method, information processing system and computer readable medium for pooling software timers. The method includes storing information associated with at least one software timer, wherein the information includes at least one of phase adjustment data and a timeout value for the at least one software timer and reading the information that was stored. The method further includes performing at least one of phase aligning the at least one software timer using the phase adjustment data and modifying the timeout value of at least one software timer, such that more than one software timer expires at the same time.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of power and workload management for computers and more particularly relates to the field of timer interrupt management.

### BACKGROUND OF THE INVENTION

Non-real-time operating systems rely on a periodic timer interrupt. A periodic timer interrupt is used by the operating system to keep track of process times, facilitate multitasking, determine if software timers has expired, and keep track of time. The repetition time interval of the timer interrupt is configured at OS startup time by writing an appropriate value into the load register of a hardware timer. In turn, the timer loads this value into a countdown register which decrements at a well known speed. When the counter reaches zero, the timer generates an interrupt. The timer then automatically reloads the initial load value into the countdown register and the count down process starts all over again. The net effect is that the timer has been setup to generate periodic timer interrupts.

On every timer interrupt, the timer interrupt service routine (ISR) is executed. The ISR updates time variables such as OS time and process times, as well as checks status of queues and lists and correspondingly run content or mark content for execution. One particularly interesting context is when the operating system (OS) is idling, i.e., when there is no computational work to be done. This happens when there are no processes actively running, no tasks on the queues and no expired software timers. The idle context is interesting in that in an OS like LINUX, and other non-real-time OSs, the only useful thing, if any, that happens in a “workless” timer interrupt is the updating of the OS time. It can be demonstrated that the servicing of the timer interrupt can be postponed until there is real work to be done while still maintaining OS time. This is accomplished by incorporating a so-called work dependent timing (WDT) scheme into the OS. The WDT scheme skips workless timer interrupts by parsing the software timer list, retrieving the timeout value of that software timer that has the nearest timeout value, reprogramming the hardware timer with the nearest timeout value and reading time from a real-time clock on every hardware interrupt.

Skipping “workless” timer interrupts has several power benefits. Firstly, it is wasteful to service workless timer interrupts. Secondly, it can be demonstrated that by skipping timer interrupts it may be possible to transition into a more efficient low power state while the OS is idling. Lastly, it can be shown that in certain classes of small form-factor mobile devices, the skipping of the timer interrupts results in significant energy savings from the elimination of transition energies associated with exploiting certain highly efficient low power states.

Another interesting scenario where skipping timer interrupts is important is in systems that run multiple images of the OSs. In such systems the accumulated impact from workless timer interrupts has a significant impact on the processor workload as well as consume unnecessary energy. Obviously when skipping workless timer interrupts, this workload is significantly reduced.

Even though power and workload is reduced by skipping workless timer interrupts, excess power is still consumed and excess workload still exists due to work related timer interrupts. Some of this excess power and workload is a direct outcome of the uncoordinated manner with which the work related timer interrupts occur.

Therefore, a need exists to overcome the problems with the prior art as discussed above, and particularly for a way to manage multiple software timers for optimum efficiency.

### SUMMARY OF THE INVENTION

Briefly, according to an embodiment of the present invention, a method for pooling software timers is disclosed. The method includes storing information associated with at least one software timer, wherein the information includes phase adjustment data and a timeout value for the at least one software timer and reading the information that was stored. The method further includes performing at least one of phase aligning the at least one software timer using the phase adjustment data and modifying the timeout value of at least one software timer, such that more than one software timer expires at the same time.

Also disclosed is an information processing system for pooling timers. The information processing system includes a memory for storing information associated with at least one timer, wherein the information includes at least one of phase adjustment data and a timeout value for the at least one timer. The processor is further configured for reading the information that was stored and performing at least one of phase aligning the at least one timer using the phase adjustment data and modifying the timeout value of at least one timer, such that more than one timer expires at the same time.

The method can also be implemented as machine executable instructions executed by a programmable information processing system or as hard coded logic in a specialized computing apparatus such as an application-specific integrated circuit (ASIC). Thus, also disclosed is a computer readable medium including computer instructions for pooling timers. The computer readable medium includes instructions for storing information associated with at least one timer, wherein the information includes at least one of phase adjustment data and a timeout value for the at least one timer and reading the information that was stored. The computer readable medium further includes instructions for performing at least one of phase aligning the at least one timer using the phase adjustment data and modifying the timeout value of at least one timer, such that more than one timer expires at the same time

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a graph showing timer interrupts that have been aligned according to one embodiment of the present invention.

FIG. 2 is a block diagram showing the high level architecture of one embodiment of the present invention.

FIG. 3 is a block diagram showing the main components of one embodiment of the present invention.

FIG. 4 is a flowchart showing the control flow of the process of one embodiment of the present invention.

FIG. 5 is a high level block diagram showing an information processing system useful for implementing one embodiment of the present invention.

### DETAILED DESCRIPTION

The present invention overcomes the problems with the prior art as discussed above by reducing the number of work related interrupts. The present invention is beneficial as it allows for reductions in power consumption and in computational load in a real-time operating system (OS) and in an OS that skips workless timer interrupts.

The present invention allows an OS to manipulate the timeout value of software timers. The OS can phase align software timers and change the timeout values of software timers for the purpose of pooling, or grouping, them together. This results in a further reduction in the number of work related timer interrupts, since pooling the software timers encourages expiration of multiple software timers in a single timer interrupt.

In an embodiment of the present invention, an OS implementing the present invention utilizes a WDT timing scheme which skips workless timer interrupts as outlined above. The OS ensures that a hardware timer will be programmed to wake up the OS in due time to call an expired software timers callback function. The hardware timer is programmed with the smallest timeout value amongst all the timers in the software timer list.

The present invention effectuates software timer pooling in order to reduce power consumption and workload of an information processing system. Below is a brief description of timer pooling as performed by one embodiment of the present invention. In the following, a “timer pop” is used to refer to the expiration of one or more software timers at a particular moment. The term “phase shifting” is used to refer to the act of displacing, or shifting, the times that a periodic timer pop occurs. The term “phase aligning” is used to refer to the act of phase shifting one or more periodic timers for the purpose of promoting that at least one timer pop coincides with the timer pop of another software timer. Phase shifting may be a one time adjustment to the phase, or it may be spread out over several timer pops. Phase shifting should not impact the long term periodicity of a periodic timer.

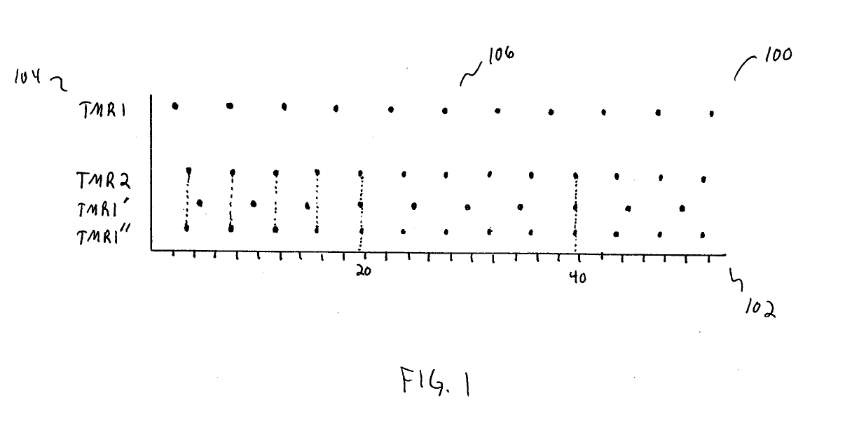

FIG. 1 is a graph 100 showing timer interrupts that have been aligned according to one embodiment of the present invention. Graph 100 shows the passage of time in two second increments along the x-axis 102. The y-axis 104 shows a list of timer interrupts. The body of graph 100 shows the placement of dots 106 representing a timer expiration, or timer pop, occurring at a particular time described by the x-axis 102. Graph 100 shows a first timer TMR1 that expires every 5 seconds. TMR1 appears to expire at 2 seconds, 7 seconds, 12 seconds, etc. Graph 100 also shows a second timer TMR2 that expires every 4 seconds. TMR2 appears to expire at 4 seconds, 8 seconds, 12 seconds, etc.

As described above, the TMR1 is phase aligned with TMR2 such that both timers expire at the same time, thus resulting in TMR1′. Generally, phase alignment of two timers results in simultaneous timer pops at least every (period1×period2) seconds, wherein period1 is the period of the first timer and period2 is the period of the second timer. Thus, comparing TMR1′ with TMR2, the graph 100 shows simultaneous timer pops at 20 seconds and 40 seconds.

Next, it is determined by the OS that the period of TMR1 can be adjusted to within +/−1 second, allowing for the period of TMR1 to be adjusted to 4 seconds. This results in TMR1″, which is identical to TMR2. Thus, comparing TMR1″ with TMR2, the graph 100 shows simultaneous timer pops at 4 seconds, 8 seconds, 12 second, etc.

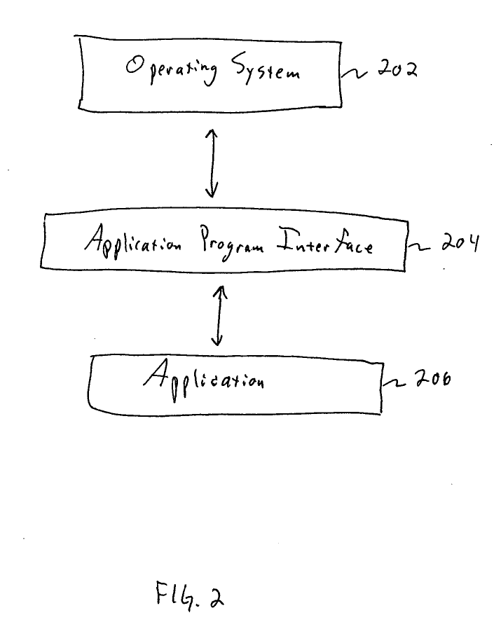

FIG. 2 is a block diagram showing the high level architecture of one embodiment of the present invention. The block diagram of FIG. 2 shows an operating system 202 representing an operating system, such as Microsoft Windows, LINUX, UNIX, DOS, Mac OS, OS-9, QNX, or any other type of operating system. FIG. 2 further shows an application 206 representing any type of program executing under the OS 202, such as a word processor, a web browser, an email client, a video game, a device driver or the OS itself. The application 206 can also be a process thread. The application 206 sets a timer, such as a periodic timer that commences when the application 206 is executed and periodically expires.

FIG. 2 further shows an application program interface (API) 204 that acts as an interface between the operating system 202 and application programs 206, including the way the application programs 206 communicate with the operating system 202, and the services the operating system 202 makes available to the applications 206. The application 206 communicates with the OS 202 via the API 204. The OS 202 implements the timer pooling function, or method, of the present invention. The API 204 exports the timer pooling functions and data structures of the present invention. In doing so, the application 206 communicates timer information to the OS 202 via the API 204. The OS 202 uses this timer data (together with timer data associated with other applications) to pool multiple timers together to reduce work load and energy consumption of the information processing system executing the application 206, OS 202 and API 204. The process of pooling timers is described in more detail below.

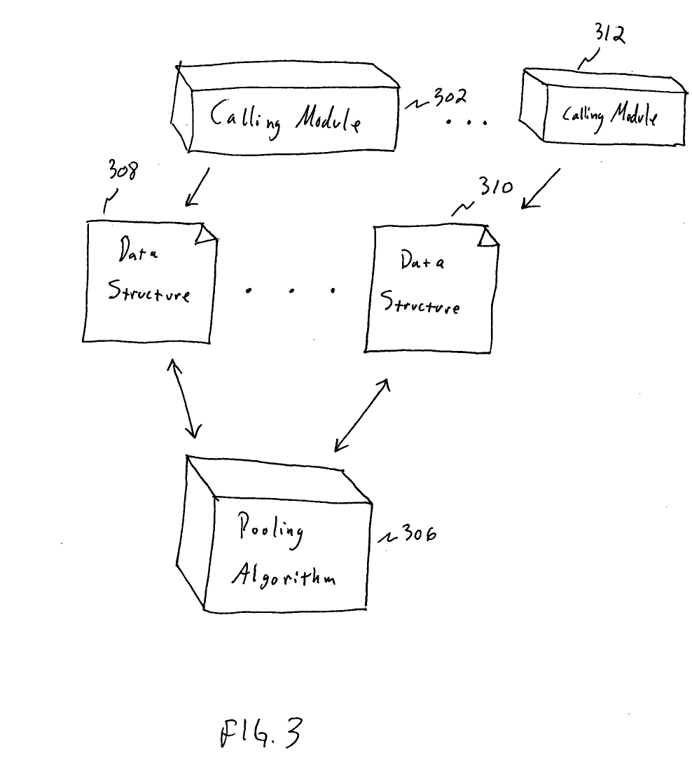

FIG. 3 is a block diagram showing the main components of one embodiment of the present invention. FIG. 3 shows a calling module 302 which would typically be a device driver or a process thread but is not limited thereto. The calling module 302 falls within the confines of an application such as the application 206. The calling module 302 instantiates a data structure 308 that holds data associated with a timer. FIG. 3 further shows another calling module 312 that instantiates a data structure 310 that holds data associated with another timer. Although FIG. 3 shows only two calling modules 302, 312 and two data structures 308, 310, the present allows for any number of calling modules and data structures. It should also be noted that a calling module can instantiate more than one data structure. Pooling algorithm 306 utilizes the data within each data structures 308 through 310 to pool multiple timers together to reduce work load and energy consumption of the information processing system. With respect to FIG. 2, a calling module, say calling module 302, resides within the confines of an application 206 and the pooling algorithm 306 resides within the confines of the OS 202.

In the following, the term “timeout value” is defined as the time at which a software timer must expire and the associated timer callback function must be executed.

From a software flow perspective, a software timer works as follows. The calling module 302 in the application 206 defines a timer callback function, callback_fct( ). The calling module 302, such as a device driver module or a user application, may sign up for a callback by making a call to add_timer(timer) which is exported by the API 204. add_timer( ), which is a function of the OS 202, adds a pointer to timer to a timer list and where timer is a software data structure which has at least two members: callback_fct, which contains the address of callback_fct( ), and expires, which contains the associated timer expiration time, or timeout value. The callback function is called by the OS 202 after the timeout interval of the timer.

Below is an example of a C++ style definition of a timer data structure, timer_pool, suitable for timer pooling. timer_pool is used for communicating timer parameters to the OS 202 and is suitable for inserting a timer into a double linked list. Note that “OS” and “CM” indicates whether it is the OS 202 or the calling module 302, respectively, which controls the data structure member, i.e., which is permitted to change it.

struct pool_timer {

| | | |
|---|---|---|
| struct pool_timer *prev; | /* OS: Pointer to previous timer in timer list. | */ |
| struct pool_timer *next; | /* OS: Pointer to next timer in timer list. | */ |
| long *callback_fct; | /* CM: Address of callback function. | */ |
| long data; | /* CM: Data for the callback function. | */ |
| long period; | /* CM: Long term average periodicity. | */ |
| long expires_min; | /* CM/OS: Lower bound on expiration time. | */ |
| long expires_pref; | /* CM: Preferred value of expiration time. | */ |
| long expires_max; | /* CM/OS: Upper bound on expiration time. | */ |
| long phase_min; | /* CM/OS: Lower bound on one-time phase adjustment. | */ |
| long phase_max; | /* CM/OS: Upper bound on one-time phase adjustment. | */ |
| long expires_os_min; | /* OS: Lower bound on expiration time. | */ |
| long expires_os; | /* OS: Running and final expiration time. | */ |

};

Referring to the C++ style definition above, the data structure members prev and next are pointers to the previous and next timers in the linked list. The data structure members callback_fct and data are the usual callback address and callback data of a timer function. The last nine members enables the OS 202 and pooling algorithm 306 to pool timers.

The data structure member period is the long term average periodicity of the timer. If the calling module 302 supplies a value of zero in this member, the OS 202 ignores it and treats the timer as a one-shot timer. If a non-zero value is supplied, the OS 202 interprets this in two ways. Firstly, the OS 202 assumes responsibility for maintaining the timer. Secondly, the OS 202 must ensure that the supplied value for the periodicity is obeyed. The purpose of this member and the implementation of the function for maintaining the timer are described in greater detail below. The calling module 302 can take over control at any time by deleting the timer and adding a new timer in which period has a value of zero. The OS 202 always updates the expires_os member to enable the calling module to keep an eye on the timer.

The data structure members expires_min and expires_max represent the minimum and maximum values of the timeout value. They are initially supplied by the calling module 302. The OS 202 may update these values for OS-maintained periodic timers. The data structure members phase_min and phase_max represent the minimum and maximum values of a phase shift, or phase adjustment, that may be used by the OS 202 in an accumulated fashion. Together, these four values are used by the OS 202 to calculate the bounds of the actual timeout value which is eventually programmed into the hardware timer. The data structure members phase_min and phase_max allow the OS 202 to insert a timer, in a more coarse fashion, into the rhythm of all the other timers. For an OS-maintained periodic timer (i.e., period>0), these members may only be used once. The manner in which these data structure members are utilized is described in greater detail below.

The data structure member expires_pref is the preferred value of the timeout value. It is only used for one-shot timers and is ignored for non-zero values in period. A value outside the range between expires_min and expires_max is ignored. Only the calling module can modify this data member.

The data structure member expires_os_min is a lower boundary value for the actual timeout value. This member is calculated by the OS 202 as expires_os_min=expires_min+phase_min. The data structure member expires_os is the running timeout value initially calculated by the OS 202 as expires_os=expires_max+phase_max but which may later change, e.g., at the time of programming the hardware timer. The purpose of this data structure member is to enable the calling module 302 to keep track of the actual timeout values for guaranteeing a certain long-term averaged periodicity. For example, this may be required by multimedia applications that can tolerate momentary variations in the callback time. expires_os is not trustworthy until its timer expires, as explained more fully below. For an OS-maintained timer, all three members are updated every time the timer expires. The manner in which these data structure members are utilized is described in greater detail below.

The timer pooling algorithm 306 takes into consideration all existing timers and uses the associated values passed in the data structure 308. It is assumed that timers are added to the double linked timer list described above and that timers are inserted in order of increasing value of expires_os which contains the maximum allowable timeout value as described above. The timer that has the nearest, i.e., shortest, timeout value in the list is denoted as timer0.

The hardware timer is only reprogrammed in two instances: when the OS 202 enters the WDT timing mode (i.e., when there is no work to be done) and when the OS 202 enters the conventional periodic timing (PT) mode which is entered when there is work to be done. It is when entering the WDT mode that the timer pooling algorithm is applied. When entering the PT mode, the hardware timer is programmed to generate periodic timer interrupts. PT mode is always entered whenever a hardware interrupt is detected by the OS. When it is time to reprogram the hardware timer in the WDT mode, the OS first evaluates and modifies the timer list as shown in the C++ code below which defines a timer pooling function 306, timer_pooling( ), suitable for pooling timers together. Briefly, timer_pooling( ) first determines if a timer can be pooled together with the head timer, timer0, then calculates its new timeout value and then repositions the pool timer within the timer list. All timers in the timer list are examined. Typically timer_pooling( ) would be called upon entering the WDT mode.

void timer_pooling (struct pool_timer *timer0)
{

| struct pool_timer *timerI; | | |
|---|---|---|
| timerI = timer0−>next; | /*Get next timer. | */ |
| while ( timerI != timer0 ) { | /*Check all the timers. | */ |

| | |
|---|---|
| if ( timerI−>expires_os_min<timer0−>expires_os ) | { |

| /* Next timer is in range of timer0! */ | | |
|---|---|---|
| timerI−>expires_os = timer0−>expires_os; | /*Adjust pool timer timeout. | */ |
| timerI = timerI−>next; | /*Get next timer. | */ |
| timerI−>prev−>prev = timer0; | /*Group pool timer w/timer0. | */ |
| timerI−>prev−>next = timer0−>next; | /*Group pool timer w/timer0. | */ |
| timer0−>next = timerI; | /*Group pool timer w/timer0. | */ |

} else

/* Next timer is NOT in range of timer0! */

| | | |
|---|---|---|
| timerI = timerI−>next; | /* Get next timer. | */ |

}

}

The basic approach to pooling timers, as exemplified above, is to stretch the timeout value of the nearest timer(s) as much as possible on every reprogramming of the hardware timer in WDT mode. The nearest timer, timer0, is always at its maximum timeout value and is used as the reference point for adjusting other potential pool timers in the timer list which generally have longer timeout values, though they may also have the same timeout value as timer0. An adjusted pool timer is never moved to the head position, but rather is inserted after timer0. Note that timer0 is always assumed to have the maximum timeout value in the expires_os. As may be seen from the C++ code above, the pool timers that are grouped with timer0 do not necessarily have the maximum possible timeout value in the expires_os. The adjusted timers merely have the same value in expires_os as timer0 does. The only instances where timer0 must be replaced is 1) if it is deleted, 2) if it is moved, or 3) if a new timer is added which has a smaller timeout value.

Currently, in certain operating systems such as LINUX, a timer is deleted from the linked list when it expires. Second, if the deleted timer is a periodic timer, the calling module that owns the timer will subsequently add a new timer. The purpose of the period member in the pool_timer structure above is to eliminate these two steps. Instead, on expiration of the timer, the OS 202 adds the value of period to the timeout boundary values, expires_min and expires_max, recalculates expires_os, as described earlier, and then moves the timer to the proper position in the linked list according to the value of expires_os. The various timeout values of an expired OS-maintained period timer may be updated as shown in the C++ code below which defines a function, add_timer( ), suitable for determining timeout boundary values in timers, including OS-maintained periodic timers.

void add_timer(struct pool_timer *timer, int type)
{

long phase_min, phase_max;
switch (type) {

case NEW_TIMER:
timer−>expires_os_min = timer−>expires_min + timer−>phase_min;
timer−>expires_os = timer−>expires_max + timer−>phase_max;
break;
case PERIODIC_TIMER:
/* Adjust remaining phase usage. */
phase_min = timer−>expires_os − timer−>expires_os_min;
if ( phase_min>=timer−>phase_min && phase_min<0 )

| | |
|---|---|
| timer−>phase_min = timer−>phase_min − phase_min; | /*Rem. phase_min usage.*/ |

phase_max = timer−>expires_os − timer−>expires_os_max;
if ( phase_max<=timer−>phase_max && phase_max>0 )

| | |
|---|---|
| timer−>phase_max = timer−>phase_max − phase_mex; | /*Rem. phase_max usage.*/ |

| /* Calculate new boundaries for timeout value. */ | |
|---|---|
| timer−>expires_min = timer−>expires_min + period; | /*New expires_min.*/ |
| timer−>expires_max = timer−>expires_max + period; | /*New expires_max.*/ |

timer−>expires_os_min = timer−>expires_min +

| | |
|---|---|
| timer−>phase_min; | /*New min. bound.*/ |

timer−>expires_os = timer−>expires_max +

| | |
|---|---|
| timer−>phase_max; | /*New max. bound.*/ |

break;
default:
break;

| } | |
|---|---|
| insert_timer(timer); | /*Add timer to linked list.*/ |

}

After updating the data members of a new timer or after updating the timeout value of a periodic timer, the timer must be either added to the timer list or repositioned in the timer list, respectively, which is done in insert_timer( ). insert_timer( ) can easily determine if timer is a new or existing timer by examining the the *prev and *next pointers which will only point to the null address if the timer is new. Inserting timers into a linked list is well known to anyone skilled in the art of systems programming.

An extension to the data structure 308 includes a data structure member representing limits on the timer's jitter in the case of an OS-maintained periodic timer. Another extension to the data structure 308 includes a data structure member representing the time duration over which the periodicity specified in period must be maintained. In the embodiments above, the periodicity is only guaranteed to be within the timeout limits represented by expires_min and expires_max.

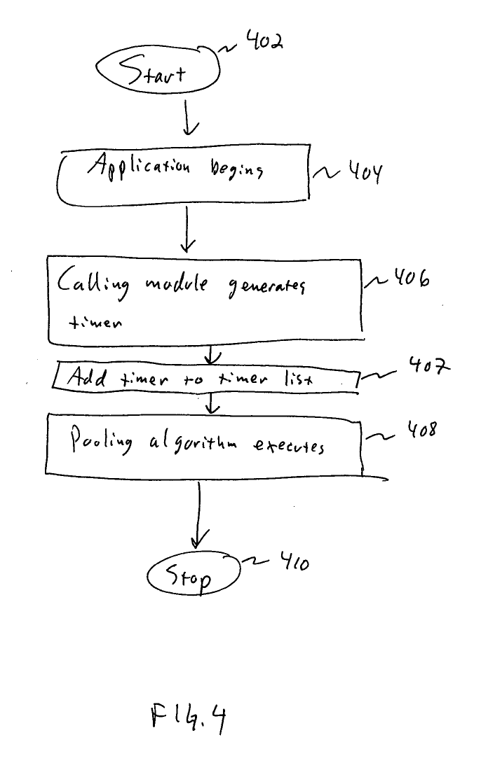

FIG. 4 is a flowchart showing the control flow of the process of one embodiment of the present invention. FIG. 4 shows the process by which the components of FIG. 3 interact in order to effectuate the timer pooling processes of the present invention. The control flow of FIG. 4 begins with step 402 and flows directly to step 404. In step 404, an application begins execution on an information processing system. In step 406, a calling module 302 of the application 206 instantiates and populates a data structure 308 and requests the OS 202 to generate a timer. In step 407, the OS 202 reads the information in the data structure 308 and inserts the timer in the timer list. Later on in step 408 the pooling algorithm executes using the data structure information, resulting in the pooling of the timer with others. Note that in the preferred embodiment the step 408 generally does not occur in immediate succession of step 407. Further note that other code, not related to timer pooling, may execute between the steps in FIF. 4. In step 410, the process of the control flow of FIG. 4 stops. It should be noted that although FIG. 4 describes only one application and one calling module, the present invention supports any number of applications and calling modules. It is also noted that even though FIG. 4 shows that

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Hard disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

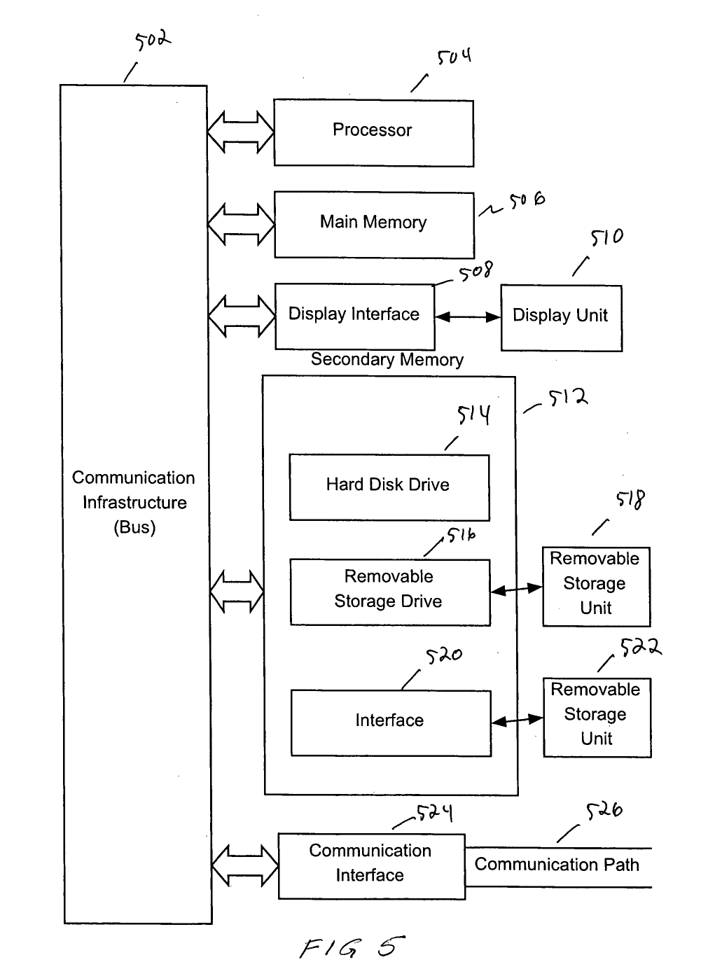

FIG. 5 is a high level block diagram showing an information processing system useful for implementing one embodiment of the present invention. The computer system includes one or more processors, such as processor 504. The processor 504 is connected to a communication infrastructure 502 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 508 that forwards graphics, text, and other data from the communication infrastructure 502 (or from a frame buffer not shown) for display on the display unit 510. The computer system also includes a main memory 506, preferably random access memory (RAM), and may also include a secondary memory 512. The secondary memory 512 may include, for example, a hard disk drive 514 and/or a removable storage drive 516, representing a floppy disk drive, a magnetic tape drive, an optical disk drive, etc. The removable storage drive 516 reads from and/or writes to a removable storage unit 518 in a manner well known to those having ordinary skill in the art. Removable storage unit 518, represents a floppy disk, a compact disc, magnetic tape, optical disk, etc. which is read by and written to by removable storage drive 516. As will be appreciated, the removable storage unit 518 includes a computer readable medium having stored therein computer software and/or data.

In alternative embodiments, the secondary memory 512 may include other similar means for allowing computer programs or other instructions to be loaded into the computer system. Such means may include, for example, a removable storage unit 522 and an interface 520. Examples of such may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to the computer system.

The computer system may also include a communications interface 524. Communications interface 524 allows software and data to be transferred between the computer system and external devices. Examples of communications interface 524 may include a modem, a network interface (such as an Ethernet card), a communications port, a PCMCIA slot and card, etc. Software and data transferred via communications interface 524 are in the form of signals which may be, for example, electronic, electromagnetic, optical, or other signals capable of being received by communications interface 524. These signals are provided to communications interface 524 via a communications path (i.e., channel) 526. This channel 526 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 506 and secondary memory 512, removable storage drive 516, a hard disk installed in hard disk drive 514, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 506 and/or secondary memory 512. Computer programs may also be received via communications interface 524. Such computer programs, when executed, enable the computer system to perform the features of the present invention as discussed herein. In particular, the computer programs, when executed, enable the processor 504 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method comprising:
storing information associated with at least one software timer, wherein the information includes at least one of phase adjustment data and a timeout value for the at least one software timer;
reading the information that was stored;
performing at least one of:
phase aligning the at least one software timer using the phase adjustment data such that more than one software timer expires at the same time; and
modifying the timeout value of at least one software timer such that more than one software timer expires at the same time.

2. The method of claim 1, wherein the element of storing further comprises:
storing for each software timer a period timeout value, a preferred timeout value, a lower bound of the timeout value, an upper bound of the timeout value, a lower bound on a phase adjustment value and an upper bound on a phase adjustment value.

3. The method of claim 2, wherein the element of storing further comprises:
storing information associated with at least one software timer in a data structure that is instantiated by a calling module.

4. The method of claim 2, wherein the element of phase aligning further comprises:
phase aligning the at least one software timer using the lower bound on a phase adjustment value and the upper bound on a phase adjustment value, such that more than one software timer expires at the same time.

5. The method of claim 2, wherein the element of modifying further comprises:
modifying the timeout value of at least one software timer using the lower bound of the timeout value and the upper bound of the timeout value, such that more than one software timer expires at the same time.

6. An information processing system, comprising:
a memory for storing information associated with at least one timer, wherein the information includes at least one of phase adjustment data and a timeout value for the at least one timer; and
a processor configured for:
reading the information that was stored; and
performing at least one of:
phase aligning the at least one timer using the phase adjustment data such that more than one timer expires at the same time; and
modifying the timeout value of at least one timer such that more than one timer expires at the same time.

7. The information processing system of claim 6, wherein the memory is further for:
storing for each timer a period timeout value, a preferred timeout value, a lower bound of the timeout value, an upper bound of the timeout value, a lower bound on a phase adjustment value and an upper bound on a phase adjustment value.

8. The information processing system of claim 7, wherein the processor is further configured for:
phase aligning the at least one timer using the lower bound on a phase adjustment value and the upper bound on a phase adjustment value, such that more than one timer expires at the same time.

9. The information processing system of claim 7, wherein the processor is further configured for:
modifying the timeout value of at least one timer using the lower bound of the timeout value and the upper bound of the timeout value, such that more than one timer expires at the same time.

10. The information processing system of claim 6, further comprising:
a calling module for instantiating in the memory the information associated with the plurality of timers.

11. The information processing system of claim 6, wherein the processor comprises an application specific integrated circuit.

12. The information processing system of claim 6, wherein the memory is further for storing instructions for:
storing information associated with at least one timer, wherein the information includes at least one of phase adjustment data and a timeout value for the at least one timer;
reading the information that was stored;
performing at least one of:
phase aligning the at least one timer using the phase adjustment data such that more than one timer expires at the same time; and
modifying the timeout value of at least one timer such that more than one timer expires at the same time.

13. The information processing system of claim 6, wherein the memory comprises a read-only memory.

14. The information processing system of claim 6, wherein the memory comprises a random-access memory.

15. A computer readable medium including computer instructions for:
storing information associated with at least one timer, wherein the information includes at least one of phase adjustment data and a timeout value for the at least one timer;
reading the information that was stored;
performing at least one of:
phase aligning the at least one timer using the phase adjustment data such that more than one timer expires at the same time; and
modifying the timeout value of at least one timer such that more than one timer expires at the same time.

16. The computer readable medium of claim 15, wherein the instructions for storing further comprise instructions for:
storing for each timer a period timeout value, a preferred timeout value, a lower bound of the timeout value, an upper bound of the timeout value, a lower bound on a phase adjustment value and an upper bound on a phase adjustment value.

17. The computer readable medium of claim 16, wherein the instructions for storing further comprise instructions for:
storing information associated with the at least one timer in a data structure that is instantiated by a calling module.

18. The computer readable medium of claim 16, wherein the instructions for phase aligning further comprise instructions for:
phase aligning the at least one timer using the lower bound on a phase adjustment value and the upper bound on a phase adjustment value, such that more than one timer expires at the same time.

19. The computer readable medium of claim 16, wherein the instructions for modifying further comprise instructions for:
modifying the timeout value of at least one timer using the lower bound of the timeout value and the upper bound of the timeout value, such that more than one timer expires at the same time.
